(19) United States
(12) Patent Application Publication
(10) Pub. No.: US 2025/0175385 A1
(43) Pub. Date: May 29, 2025

(54) SYSTEM AND METHODS FOR CLOUD AGNOSTIC INFRASTRUCTURE PROVISIONING

(71) Applicant: SAMSUNG ELECTRONICS CO., LTD., Suwon-si (KR)

(72) Inventors: Vikas Kumar SINGH, Bengaluru (IN); Rajasekhara Reddy DUVVURU MUNI, Bengaluru Karnataka (IN); Prasanth PADMALAYAM, Bengaluru (IN); Karthikeyan KUMARAGURU, Bengaluru Karnataka (IN)

(73) Assignee: SAMSUNG ELECTRONICS CO., LTD., Suwon-si (KR)

(21) Appl. No.: 19/007,216

(22) Filed: Dec. 31, 2024

Related U.S. Application Data
(63) Continuation of application No. PCT/KR2024/018105, filed on Nov. 15, 2024.

(30) Foreign Application Priority Data
Nov. 29, 2023 (IN) 202341081021

(51) Int. Cl. H04L 41/084; H04L 41/0806; H04L 67/10

(52) U.S. Cl. CPC H04L 41/0843; H04L 41/0806; H04L 67/10

(57) ABSTRACT

A method for automatic cloud agnostic infrastructure provisioning, includes: receiving at least one system architecture design for deployment of at least one application on a cloud platform; determining: design parameters by decoding the at least one system architecture design, wherein the design parameters include at least one from among system components, one or more interconnections between the system components, performance requirements of the system components, and resource requirements of the system components; determining, based on the design parameters, at least one service component for deployment from among the system components; determining at least one Infrastructure-as-Code (IaC) template for the at least one service component based on the interconnections between the system components; and deploying the at least one application on the cloud platform based on the at least one IaC template.

### CROSS-REFERENCE TO RELATED APPLICATIONS

This application is a by-pass continuation application of International Application No. PCT/KR2024/018105, filed on Nov. 15, 2024, which is based on and claims priority to Indian Patent Application number 202341081021, filed on Nov. 29, 2023 in the Indian Patent Office, the disclosures of which are incorporated by reference herein in their entireties.

### BACKGROUND

### 1. Field

The disclosure relates to the field of cloud infrastructure management systems, and more particularly, to a cloud agnostic infrastructure provisioning method and system.

### 2. Description of Related Art

Enterprises may heavily rely on cloud infrastructure to deliver their services. However, conventional and iterative approaches for designing and migrating to cloud infrastructure may require considerable time, effort, and resources, including developing system architecture diagrams by skilled system architects or administrators, followed by pilot infrastructure tests, before provisioning at scale, for example.

### SUMMARY

According to an aspect of the disclosure, a method for automatic cloud agnostic infrastructure provisioning, includes: receiving at least one system architecture design for deployment of at least one application on a cloud platform; determining: one or more design parameters by decoding the at least one system architecture design, wherein the one or more design parameters include at least one of a plurality of system components, one or more interconnections between the plurality of system components, a plurality of performance requirements of the plurality of system components, and a plurality of resource requirements of the plurality of system components; determining, based on the one or more design parameters, at least one service component for deployment from among the plurality of system components; determining at least one Infrastructure-as-Code (IaC) template for the at least one service component based on the one or more interconnections between the plurality of system components; and deploying the at least one application on the cloud platform based on the at least one IaC template.

The at least one service component may meet the plurality of resource requirements and the plurality of performance requirements.

The at least one system architecture design may include a plurality of architecture design images of the at least one application and a plurality of design documents of the at least one application.

The decoding the at least one system architecture design may include: segmenting the at least one system architecture design into a plurality of design segments; detecting: text associated with at least one system component of the plurality of system components in the plurality of design segments, one or more links associated with the at least one system component in the plurality of design segments, and one or more icons associated with the at least one system component in the plurality of design segments; determining a plurality of types including one or more first types of the text, one or more second types of the one or more links, and one or more third types of the one or more icons; and determining the one or more design parameters based on the plurality of types.

The detecting the text may include: detecting at least one design segment from the plurality of design segments in which first text associated with the at least one system component is available; removing a maximum level of background surrounding the first text; segmenting the first text into a plurality of text segments; and detecting the text by converting a plurality of single string characters from the plurality of text segments into words.

The detecting the one or more links may include: detecting at least one design segment from the plurality of design segments in which at least one Region of Interest (ROI) is available; determining a plurality of edges of the at least one ROI; and detecting the one or more links based on the plurality of edges.

The determining the at least one service component may include: receiving the one or more interconnections between the plurality of system components and metadata associated with the plurality of system components; determining a plurality of recommended service components based on the one or more interconnections between the plurality of system components and the metadata; and determining the at least one service component from the plurality of recommended service components based on at least one machine learning model and a plurality of characteristics of one or more cloud service providers.

The determining the plurality of recommended service components may include: validating the plurality of system components to determine a validation result based on cloud component information retrieved from a component corpus database and a service component matrix, wherein the service component matrix may include information about a plurality of requirements, with respect to a plurality of cloud services provided, of a plurality of service components; determining a missing system component based on the validation result to obtain a set of system components; and determining the plurality of recommended service components by mapping the set of system components to at least one first service component of the plurality of service components based on the one or more interconnections between the plurality of system components, and the metadata associated with the plurality of system components.

The deploying the at least one application may include: obtaining at least one validated IaC template by validating the at least one IaC template for a plurality of errors and a plurality of missing code components; and deploying the at least one application on the cloud platform based on the at least one validated IaC template.

The method may further include: determining a change in the system architecture design; and automatically changing the IaC template based on the change in the system architecture design.

According to an aspect of the disclosure, an infrastructure provisioning system for automatic cloud agnostic infrastructure provisioning, includes: one or more processors; and memory storing instructions that, when executed by the one or more processors, cause the infrastructure provisioning system to: receive at least one system architecture design for deployment of at least one application on a cloud platform; determine: one or more design parameters by decoding the at least one system architecture design, wherein the one or more design parameters include at least one of a plurality of system components, one or more interconnections between the plurality of system components, a plurality of performance requirements of the plurality of system components, and a plurality of resource requirements of the plurality of system components; determine, based on the one or more design parameters, at least one service component for deployment from among the plurality of system components; determine at least one Infrastructure-as-Code (IaC) template for the at least one service component based on the one or more interconnections between the plurality of system components; and deploy the at least one application on the cloud platform based on the at least one IaC template.

The at least one service component may meet the plurality of resource requirements and the plurality of performance requirements.

The at least one system architecture design may include a plurality of architecture design images of the at least one application and a plurality of design documents of the at least one application.

The one or more processors may be configured to execute the instructions to cause the infrastructure provisioning system to: segment the at least one system architecture design into a plurality of design segments; detect: text associated with at least one system component of the plurality of system components in the plurality of design segments, one or more links associated with the at least one system component in the plurality of design segments, and one or more icons associated with the at least one system component in the plurality of design segments; determine a plurality of types including one or more first types of the text, one or more second types of the one or more links, and one or more third types of the one or more icons; and determine the one or more design parameters based on the plurality of types.

The one or more processors may be configured to execute the instructions to cause the infrastructure provisioning system to: detect at least one design segment from the plurality of design segments in which first text associated with the at least one system component is available; remove a maximum level of background surrounding the first text; segment the first text into a plurality of text segments; and detect the text by converting a plurality of single string characters from the plurality of text segments into words.

The one or more processors may be configured to execute the instructions to cause the infrastructure provisioning system to: detect at least one design segment from the plurality of design segments in which at least one Region of Interest (ROI) is available; determine a plurality of edges of the at least one ROI; and detect the one or more links based on the plurality of edges.

The one or more processors may be configured to execute the instructions to cause the infrastructure provisioning system to: receive the one or more interconnections between the plurality of system components and metadata associated with the plurality of system components; determine a plurality of recommended service components based on the one or more interconnections between the plurality of system components and the metadata; and determine the at least one service component from the plurality of recommended service components based on at least one machine learning model and a plurality of characteristics of one or more cloud service providers.

The one or more processors may be configured to execute the instructions to cause the infrastructure provisioning system to: validate the plurality of system components to determine a validation result based on cloud component information retrieved from a component corpus database and a service component matrix, wherein the service component matrix may include information about a plurality of requirements, with respect to a plurality of cloud services provided, of a plurality of service components; determine a missing system component based on the validation result to obtain a set of system components; and determine the plurality of recommended service components by mapping the set of system components to at least one first service component of the plurality of service components based on the one or more interconnections between the plurality of system components, and the metadata associated with the plurality of system components.

The one or more processors may be configured to execute the instructions to cause the infrastructure provisioning system to: obtain at least one validated IaC template by validating the at least one IaC template for a plurality of errors and a plurality of missing code components; and deploy the at least one application on the cloud platform based on the at least one validated IaC template.

According to an aspect of the disclosure, a non-transitory computer-readable recording medium having instructions recorded thereon, that, when executed by one or more processors, cause the one or more processors to: receive at least one system architecture design for deployment of at least one application on a cloud platform; determine: one or more design parameters by decoding the at least one system architecture design, wherein the one or more design parameters include at least one of a plurality of system components, one or more interconnections between the plurality of system components, a plurality of performance requirements of the plurality of system components, and a plurality of resource requirements of the plurality of system components; determine, based on the one or more design parameters, at least one service component for deployment from among the plurality of system components; determine at least one Infrastructure-as-Code (IaC) template for the at least one service component based on the one or more interconnections between the plurality of system components; and deploy the at least one application on the cloud platform based on the at least one IaC template.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 illustrates an example of manually provisioning cloud infrastructure;

FIG. 2 illustrates an example scenario depicting an approach including manual and iterative process maps for cloud infrastructure provisioning;

FIG. 3 illustrates components of an infrastructure provisioning system for automated provisioning of cloud-agnostic infrastructure, according to one or more embodiments;

FIG. 4 illustrates components of a design decoder of the infrastructure provisioning system, according to one or more embodiments;

FIG. 5 illustrates components of an artefact recommender of the infrastructure provisioning system, according to one or more embodiments;

FIG. 6 illustrates components of an infrastructure orchestrator of the infrastructure provisioning system, according to one or more embodiments;

FIG. 7 illustrates an example scenario for an automatic iterative process map of the cloud infrastructure provisioning, according to one or more embodiments;

FIG. 8 illustrates operations of the design decoder of the infrastructure provisioning system, according to one or more embodiments;

FIG. 9 illustrates operations of the artefact recommender of the infrastructure provisioning system, according to one or more embodiments;

FIG. 10 illustrates an example scenario of provisioning of an image sharing application on an AWS platform, according to one or more embodiments;

FIG. 11 illustrates an example scenario of provisioning an image sharing application on a multi-cloud and multi-region deployment of services, according to one or more embodiments;

FIG. 12 illustrates an example scenario of provisioning infrastructure for a revamped application (e.g., payment application or the like), according to one or more embodiments; and

FIG. 13 illustrates a flow chart of a method for automatic cloud agnostic infrastructure provisioning, according to one or more embodiments.

Like reference numerals may be used to represent like elements in the drawing. Further, those of ordinary skill in the art will appreciate that elements in the drawing may not be drawn to scale. For example, the dimension of some of the elements in the drawing may be exaggerated relative to other elements to facilitate understanding of aspects of one or more embodiments. Furthermore, one or more elements may be represented in the drawings by conventional symbols, and the drawings may show details to facilitate an understanding the disclosure by those of ordinary skill in the art.

### DETAILED DESCRIPTION

The embodiments described in the disclosure, and the configurations shown in the drawings, are only examples of embodiments, and various modifications may be made without departing from the scope and spirit of the disclosure.

The descriptions herein are intended to facilitate an understanding of the disclosure and to enable those of ordinary skill in the art to practice the exemplary embodiments provided herein. Accordingly, these descriptions should not be construed as limiting the scope of the disclosure.

Various embodiments may be described and illustrated in terms of blocks which carry out a described function or functions. These blocks, which may be referred to herein as managers, units, modules, hardware components or the like, may be implemented by analog and/or digital circuits such as logic gates, integrated circuits, microprocessors, microcontrollers, memory circuits, passive electronic components, active electronic components, optical components, hardwired circuits and the like, or may be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. A block of the embodiments may be separated into two or more interacting and discrete blocks without departing from the scope of the disclosure. Likewise, the blocks of one or more embodiments may be combined into more complex blocks without departing from the scope of the disclosure.

The accompanying drawings are provided to facilitate an understanding of various technical features, and the exemplary embodiments presented herein are not limited by the accompanying drawings. As such, the disclosure should be construed to extend to any alterations, equivalents and substitutes in addition to those which are set out in the accompanying drawings. Although the terms first, second, etc. may be used herein to describe various elements, these elements should not be limited by these terms. These terms are used to distinguish one element from another. Similar reference characters may denote corresponding features throughout the figures.

The various embodiments provided herein relate to a method and an infrastructure provisioning system for automatic cloud agnostic infrastructure provisioning. The method includes receiving, by the infrastructure provisioning system, a system architecture design for deployment of an application on a cloud platform. Further, the method includes determining, by the infrastructure provisioning system, one or more design parameters by decoding the system architecture design. The one or more design parameters include system components, interconnections between the system components, performance requirements of the system components, and resource requirements of the system components. Further, the method may include determining, by the infrastructure provisioning system, a service component for deployment of the system components based on the one or more design parameters. Further, the method may include determining, by the infrastructure provisioning system, an Infrastructure-as-Code (IaC) template for the service component based on the interconnections between the system components and the service component. Further, the method may include deploying, by the infrastructure provisioning system, the application on the cloud platform based on the determined IaC template.

One or more embodiments may decode architecture designs and documents. One or more embodiments may identify components tailored to meet requirements over various cloud platforms, while providing the infrastructure orchestrator. One or more embodiments may expeditiously provide industry-standard IT infrastructure, which may accelerate a time-to-market for products and may provide cost savings.

The disclosure provides various embodiments relating to designing cloud infrastructure across multiple platforms. One or more embodiments may automatically identify components and monitor performance according to system requirements. Furthermore, one or more embodiments may facilitate gathering service reliability requirements and provisioning to those specifications, while also iteratively orchestrating the service. One or more embodiments may reduce system deployment on-boarding time and costs.

A system may have the ability to populate the IaC template for a selected cloud platform. However, the process may require manual identification of platform-specific components. The method and infrastructure provisioning system, according to one or more embodiments, may use image and text processing AI technologies designed to identify cloud-related components and specifications.

A technique may be used to populate the IaC template with manual inputs pertaining to components and their specifications from the cloud administrator or engineer. The method and infrastructure provisioning system, according to one or more embodiments, exhibit the competence to design and optimize cloud infrastructure across multiple cloud platforms by identifying the components and monitoring their performance automatically based on system requirements.

A method for enhancing service reliability engineering of an already deployed service may utilize machine learning. The method and infrastructure provisioning system, according to one or more embodiments, may collect the service's reliability requisites and provisioning them to the stipulated specifications, while also iteratively orchestrating the service.

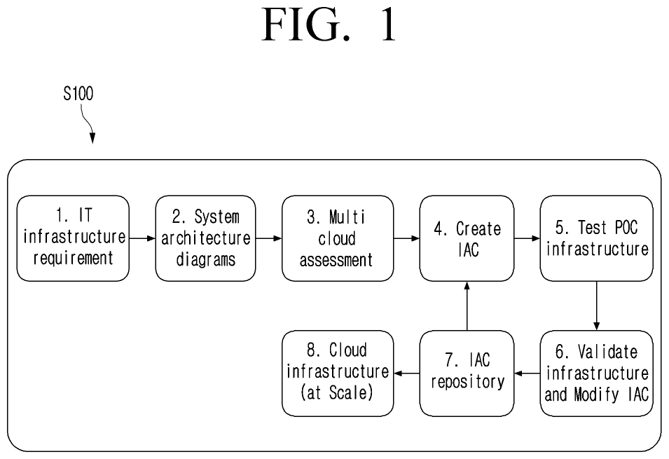

FIG. 1 illustrates an example scenario (S100) depicting manual provisioning of cloud infrastructure. At operation 1, the system receives an information technology (IT) infrastructure requirement. At operation 2, the system obtains system architecture diagrams. At operation 3, the system performs a multi-cloud assessment based on cost, IT infrastructure requirements, and the system architecture designs. At operation 4, the system generates Infrastructure-as-Code (IaC) following the multi-cloud assessment. At operation 5, the IaC is fashioned for the cloud platform used for Proof of Concept (POC) infrastructure. At operation 6, the POC infrastructure undergoes testing and validation. At operations 7 and 8, the tested and validated POC infrastructure IaC undergoes modifications to accommodate actual capacity and actual cloud infrastructure provisioning.

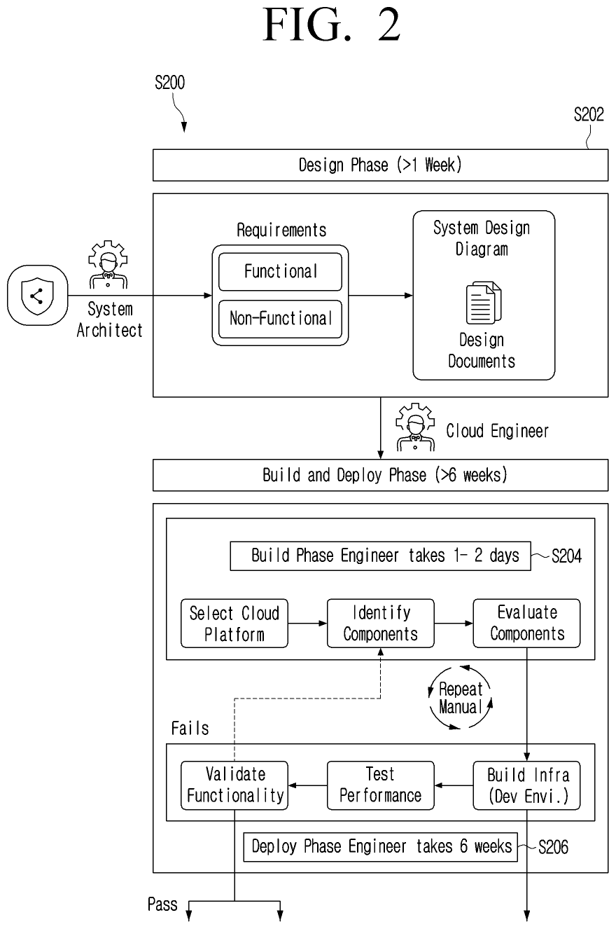

FIG. 2 illustrates an example scenario S200 including manual and iterative process maps for cloud infrastructure provisioning.

During a design phase, at operation S202, the system architect engages with stakeholders to gather various requirements. A cloud engineer may use these requirements to propose architecture designs and to determine architectural requirements.

During the build phase, at operation S204, cloud engineers possessing specialized knowledge of the cloud platform may identify the components for the system. The components may be selected by the cloud platform. In the deployment phase, at operation S206, an architecture will be provisioned in the development environment and its performance will be tested. If the performance meets requirements, the development environment may be deployed. In an exemplary embodiment, the requirements are met if the system's performance metrics (e.g., response time, throughput, and resource utilization) are within the predefined thresholds. However, when the performance does not meet the requirements, the cloud engineer may reassess the components and iteratively rebuild the infrastructure until the requirements are met.

Approaches and systems for provisioning cloud resources may demand a significant amount of manual labor and time to construct or transfer the IT framework, which may adversely affect onboarding and product launch timelines.

For an example, to develop an online gaming application to be deployed on multiple cloud platforms across various geographies with differing customer bases, a design phase may be used. During this phase, the system architect may conduct a thorough analysis of the system requirements, including both functional and non-functional aspects. Functional requirements may include user authentication and authorization, data processing and storage capabilities, as well as network security and privacy considerations, for example. Non-functional requirements may encompass aspects such as system performance and reliability, which could be measured in terms of transactions per second, system latency, or performance consistency, for example. To establish the system architecture, methods may rely on estimates for each component category.

During the building and deployment phases, the cloud engineer may select the appropriate cloud platform, such as AWS®, and may identify components that match the system requirements. After evaluating capabilities of these components, the engineer may construct infrastructure within the development environment and may test the system's functionality and performance. Once requirements are met, the cloud engineer may deploy the service architecture in the production environment of the designated cloud platform and may repeat these operations for use with another cloud platform, such as Azure or Google Cloud Platform, for different geographies or migration purposes, for example. This approach may be time-consuming and financially taxing, particularly when deploying applications like online gaming across multiple cloud platforms with varying customer bases.

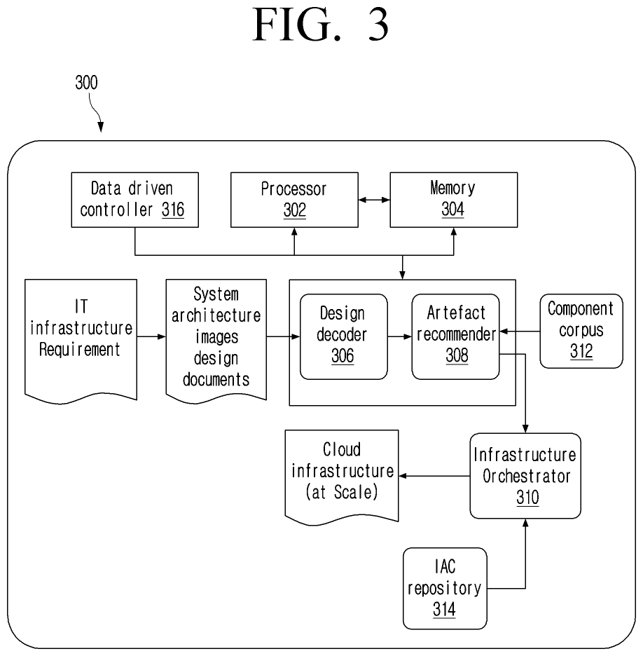

FIG. 3 illustrates components of an infrastructure provisioning system 300 for automated provisioning of cloud-agnostic infrastructure, according to one or more embodiments. According to one or more embodiments, the infrastructure provisioning system 300 may be implemented with an XR apparatus, a laptop, a notebook, a Device-to-Device (D2D) device, a vehicle to everything (V2X) device, a smartphone, a XR headset, a head mounted display, a foldable phone, a smart TV, a tablet, an immersive device, or an internet of things (IoT) device, for example.

In one or more embodiments, the infrastructure provisioning system 300 may include a processor 302, a communicator, a memory 304, a design decoder 306, an artefact recommender 308, an infrastructure orchestrator 310, a component corpus 312, an IaC repository 314 and a data driven controller 316. The processor 302 is communicatively coupled with the communicator, the memory 304, the design decoder 306, the artefact recommender 308, the infrastructure orchestrator 310, the component corpus 312, the IaC repository 314 and the data driven controller 316.

The design decoder 306 receives a system architecture design for deployment of an application (e.g., game application, chat application, finance related application, image sharing application or the like) on a cloud platform. In one or more embodiments, the system architecture design includes architecture design images and design documents of the application. The design decoder 306 may determine one or more design parameters by decoding the system architecture design. The one or more design parameters may include system components, interconnections between the system components, performance requirements of the system components, and resource requirements of the system components, for example.

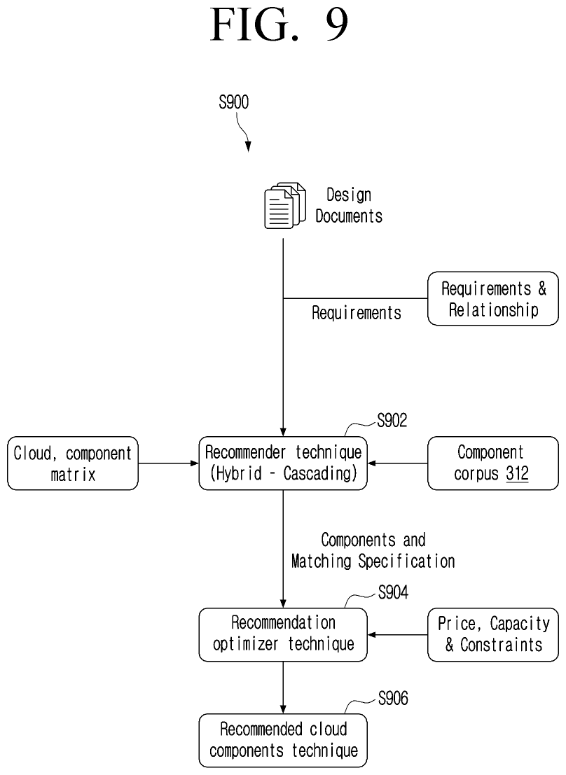

In one or more embodiments, as illustrated in FIG. 9, for example, the system architecture design may be decoded by segmenting the system architecture design into design segments, detecting text, links, and icons associated with system components in the design segments, determining types of the detected text, links, and icons, and determining one or more design parameters based on the types of the detected text, links, and icons.

In one or more embodiments, the detection of the text may be achieved by detecting a design segment from the design segments in which the text associated with the system component is available, removing a maximum level of background surrounding the text in the design segment, segmenting the text in the design segment into text segments, and converting single string characters from each text segment of the text segments into words.

In one or more embodiments, the detection of links associated with the system component in each design segment of the design segments may include identifying a design segment that contains a Region of Interest (ROI), and determining edges of the ROI to enable the detection of links within the segment. The links associated with the system component within the design segment may be detected based on the identified edges of the ROI.

According to one or more embodiments, the design decoder 306 may use analog or digital circuits, which may include logic gates, integrated circuits, microprocessors, microcontrollers, memory circuits, passive and active electronic components, optical components, or hardwired circuits, for example. The design decoder 306 may also be powered by firmware.

The artefact recommender 308 may determine the service component for deployment of the system components based on the one or more design parameters. The service component may match the resource requirements of the system components.

In one or more embodiments, the artefact recommender 308 receives the interconnections between the system components and metadata associated with the system components. Further, the artefact recommender 308 may determine recommended service components based on the interconnections between the system components and the metadata associated with the system components. In one or more embodiments, the recommended service components may be determined by validating the system components based on the cloud component information retrieved from a component corpus 312 database and a service component matrix, determining missing system components based on the validation to obtain a set of system components, and determining the recommended service components by mapping the set of system components to the service component based on the interconnections between the system components and the metadata associated with the system components. The service component matrix may include information about requirements of each service component with respect to cloud service provider.

Further, the artefact recommender 308 may determine the recommended service components based a machine learning model and characteristics of cloud service providers.

The artefact recommender 308 may be realized through analog or digital circuits, including logic gates, integrated circuits, microprocessors, microcontrollers, memory circuits, passive and active electronic components, optical components, and hardwired circuits, among others. The recommender 308 may be powered by firmware.

The infrastructure orchestrator 310 may be connected to the artefact recommender 308. The infrastructure orchestrator 310 determines an IaC template for the service component based on the interconnections between the system components. Further, the infrastructure orchestrator 310 deploys the application on the cloud platform based on the determined IaC template. In one or more embodiments, the infrastructure orchestrator 310 validates the IaC template for errors and missing code components. Further, the infrastructure orchestrator 310 deploys the application on the cloud platform based on the validated IaC template.

Further, the infrastructure orchestrator 310 determines a change in the system architecture design. Further, the infrastructure orchestrator 310 automatically changes the IaC template based on the change in the system architecture design.

According to one or more embodiments, the infrastructure orchestrator 310 may be implemented by analog or digital circuits such as logic gates, integrated circuits, microprocessors, microcontrollers, memory circuits, passive electronic components, active electronic components, optical components, hardwired circuits, or the like, or may be driven by firmware.

Further, the processor 302 is configured to execute instructions stored in a memory 304 and to perform various processes. The communicator is configured for communicating internally between internal hardware components and with external devices via one or more networks. The memory 304 also stores instructions to be executed by the processor 302. The memory 304 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 304 may, in some examples, be considered a non-transitory storage medium. The term “non-transitory” may indicate that the storage medium is not embodied in a carrier wave or a propagated signal. However, the term “non-transitory” should not be interpreted that the memory is non-movable. In one or more embodiments, a non-transitory storage medium may store data that may, over time, change (e.g., in Random Access Memory (RAM) or cache).

According to one or more embodiments, one or more of modules or controllers may be implemented through an AI model using a data driven controller 316. The data driven controller 316 may be a ML model based controller and AI model based controller. A function associated with the AI model may be performed through the non-volatile memory, the volatile memory, and the processor 302. The processor 302 may include one or more processors. At this time, one or more processors may be a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or more processors may control processing of the input data in accordance with a predefined operating rule or AI model stored in the non-volatile memory and the volatile memory. The predefined operating rule or artificial intelligence model may be provided through training or learning.

Being provided through learning indicates a predefined operating rule or AI model with one or more characteristics by applying machine learning techniques to learning data. The learning may be performed in a device in which AI according to one or more embodiments is performed, or may be implemented through a separate server or system.

The AI model may include a plurality of neural network layers. Each layer may have weight values and may perform a layer operation through calculation of a previous layer and operations on a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks, for example.

The learning technique is a method for training a predetermined target device (for example, a robot) using learning data to cause, allow, or control the target device to make a determination or prediction. Examples of learning techniques include, but are not limited to, supervised learning, unsupervised learning, semi-supervised learning, or reinforcement learning.

The infrastructure provisioning system 300 may design and adjust cloud infrastructure across multiple platforms. The infrastructure provisioning system 300 may automatically identify the components and monitor performance according to system requirements. Furthermore, the infrastructure provisioning system 300 may gather service reliability requirements and provision to those specifications, while also iteratively orchestrating the service. The infrastructure provisioning system 300 according to one or more embodiments may reduce system deployment on-boarding time and costs.

The infrastructure provisioning system 300 may use image and text processing AI technologies designed for this task to automatically identify cloud-related components and specifications. The infrastructure provisioning system 300 according to one or more embodiments may exhibit the competence to design and optimize cloud infrastructure across multiple cloud platforms by identifying the components and monitoring their performance automatically based on system requirements.

FIG. 3 illustrates hardware of the infrastructure provisioning system 300 according to one or more embodiments. However, the disclosure is not limited thereto. The infrastructure provisioning system 300 may incorporate a different number of components. Additionally, labels or names of the components are illustrative and do not limit the scope of the disclosure. One or more components may be merged to carry out the same or substantially similar functions within the infrastructure provisioning system 300.

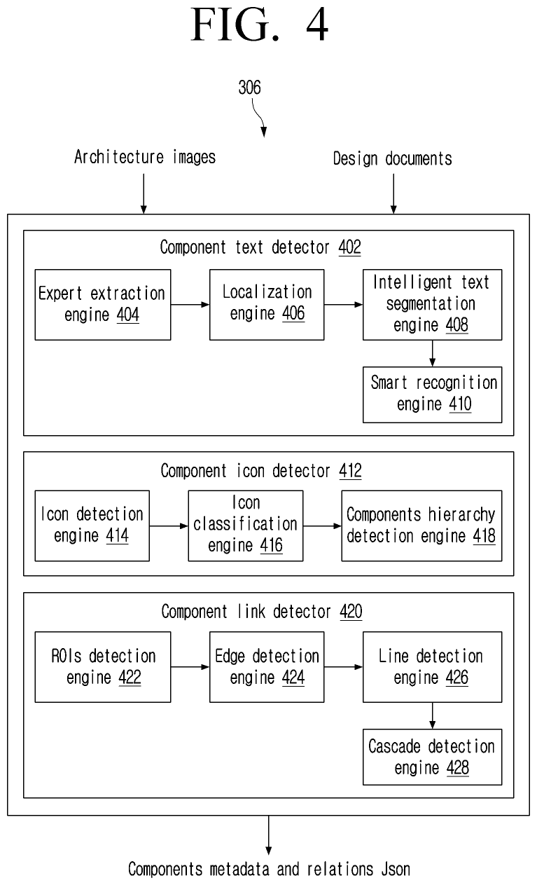

FIG. 4 illustrates components of the design decoder 306 of the infrastructure provisioning system 300, according to one or more embodiments. In one or more embodiments, the design decoder 306 includes a component text detector 402, a component icon detector 412 and a component link detector 420.

In one or more embodiments, the component text detector 402 includes an expert extraction engine 404, a localization engine 406, an intelligent text segmentation engine 408 and a smart recognition engine 410. According to one or more embodiments, the component text detector 402 may be implemented by analog or digital circuits such as logic gates, integrated circuits, microprocessors, microcontrollers, memory circuits, passive electronic components, active electronic components, optical components, hardwired circuits, or the like, or may be driven by firmware.

In one or more embodiments, the component icon detector 412 includes an icon detection engine 414, an icon classification engine 416 and a components hierarchy detection engine 418. According to one or more embodiments, the component icon detector 412 may be implemented by analog or digital circuits such as logic gates, integrated circuits, microprocessors, microcontrollers, memory circuits, passive electronic components, active electronic components, optical components, hardwired circuits, or the like, or may be driven by firmware.

In one or more embodiments, the component link detector 420 includes a ROIs detection engine 422, an edge detection engine 424, a line detection engine 426 and a cascade detection engine 428. According to one or more embodiments, the component link detector 420 may be implemented by analog or digital circuits such as logic gates, integrated circuits, microprocessors, microcontrollers, memory circuits, passive electronic components, active electronic components, optical components, hardwired circuits, or the like, or may be driven by firmware.

The system architecture designs may include text, icons and links. The component corpus 312 is used for detecting components. The expert extraction engine 404 identifies the text lied in the system architecture images. The localization engine 406 applies intelligent process and removes maximum amount of background surrounding the text. The intelligent text segmentation engine 408 extracts and retrieves the bounded text from the background. The smart recognition engine 410 converts the single string characters into character of words or string by character recognition and word recognition. The components name and metadata is populated into JSON or a database.

The icon detection engine 414 uses computer vision techniques to identify the icons. The icon classification engine 416 classifies the icons and associated types based on the component corpus 312. The components hierarchy detection engine 418 detects component nesting and finds component families. The component metadata JSON is updated with second level information.

The ROIs detection engine 422 detects regions of interest for detecting links. The edge detection engine 424 detects the edges as features for the line detection. The line detection engine 426 detects connections between components. The cascade detection engine 428 detects cascading components and component hierarchies. The component metadata JSON is updated with the third level information.

FIG. 4 illustrates components of the design decoder 306. However, the disclosure is not limited thereto. In one or more embodiments, the design decoder 306 may include more components, for example. Further, the labels or names of the components are used for illustrative purpose and do not limit the scope of the disclosure. One or more components may be combined to perform the same or substantially similar function.

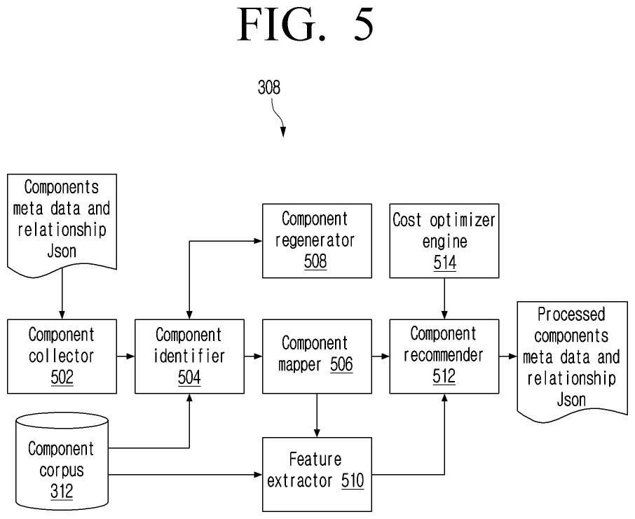

FIG. 5 illustrates components of the artefact recommender 308 of the infrastructure provisioning system 300, according to one or more embodiments. In one or more embodiments, the artefact recommender 308 includes a component collector 502, a component identifier 504, a component mapper 506, a component regenerator 508, a feature extractor 510, a component recommender 512 and a cost optimizer engine 514, for example.

The components metadata and relationship JSON inputs to the component collector 502. The component collector 502 reads and analyzes the components and relationships. The component identifier 504 identifies, determines, and validates component details based on a component corpus 312 master. The component regenerator 508 may fill missing components. The component mapper 506 maps the components and interrelations to different cloud components. The cost optimizer engine 514 optimizes components selection based on its knowledge base. The component recommender 512 fills and suggest components based on industry practices and a ML recommendation engine. The components metadata JSON is updated with the new metadata. The feature extractor 510 may be coupled with the component recommender 512.

According to one or more embodiments, the component collector 502, the component identifier 504, the component regenerator 508, the component mapper 506, the cost optimizer engine 514 and the component recommender 512 may be implemented by analog or digital circuits such as logic gates, integrated circuits, microprocessors, microcontrollers, memory circuits, passive electronic components, active electronic components, optical components, hardwired circuits, or the like, or may be driven by firmware.

FIG. 5 illustrates components of the artefact recommender 308. However, the disclosure is not limited thereto. In one or more embodiments, the artefact recommender 308 may include more components, for example. Further, the labels or names of the components are used for illustration and do not limit the scope of the disclosure. One or more components may be combined together to perform the same or substantially similar function.

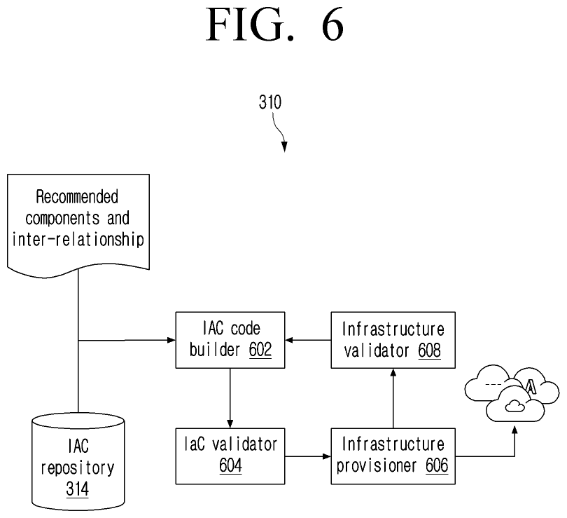

FIG. 6 illustrates components of the infrastructure orchestrator 310 included in the infrastructure provisioning system 300, according to one or more embodiments. In one or more embodiments, the infrastructure orchestrator 310 includes an IaC code builder 602, an IaC validator 604, an infrastructure provisioner 606 and an infrastructure validator 608. The IaC code builder 602 is an AI-ML module and loads IaC code from the repository for customization. The IaC code builder 602 may use technology stack requirements inferred from components and relationship JSON. The IaC validator 604 validates the generated code for errors and missing code components. The Infrastructure provisioner 606 validates the IaC Code deployed for sandbox/development environment. The deployed infrastructure for the sandbox/development environment may be validated by the infrastructure validator 608 and final IaC Codes may be sent to the infrastructure provisioner 606 for final deployment.

According to one or more embodiments, the IaC code builder 602, the IaC validator 604, the infrastructure provisioner 606 and the infrastructure validator 608 may be implemented by analog or digital circuits such as logic gates, integrated circuits, microprocessors, microcontrollers, memory circuits, passive electronic components, active electronic components, optical components, hardwired circuits, or the like, or may be driven by firmware.

FIG. 6 illustrates components of the infrastructure orchestrator 310. However, the disclosure is not limited thereto. In one or more embodiments, the infrastructure orchestrator 310 may include less or more number of components. Further, the labels or names of the components are used for illustration and do not limit the scope of the disclosure. One or more components can be combined together to perform same or substantially similar function in the infrastructure orchestrator 310.

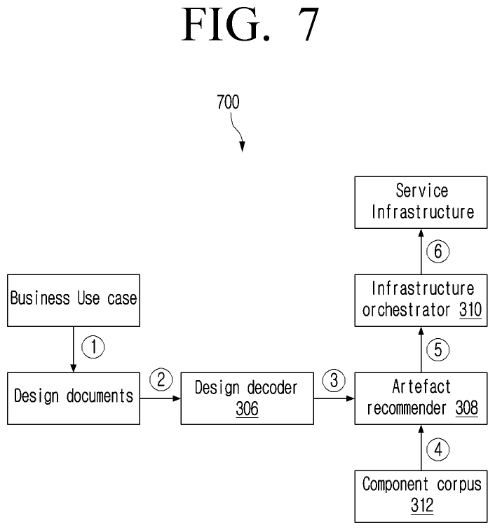

FIG. 7 is an example scenario 700 in which the automatic iterative process map of the cloud infrastructure provisioning is explained, according to one or more embodiments.

At operation 1 and operation 2, the system feds with the system design images and documents to the AI-ML based system. At operation 3, the design decoder 306 (e.g., ML system design decoder or the like) detects all components and its relationship. At operation 4 and operation 5, the artefact recommender 308 checks and maps the best cloud platform and the service components based on component corpus 312 and AI model. At operation 6, the infrastructure orchestrator 310 may identify an IaC template from the IaC Repo and may customize the IaC template. The infrastructure orchestrator 310 validates the IaC template and determines a cloud Infrastructure.

For organizations that use cloud infrastructure, the system architects may determine system designs and the design documents. The system design and requirements ingested by the design decoder 306. The design decoder 306 decodes the designs to system components and their interconnections. The artefact recommender 308 takes the system components, their interconnections and component corpus 312 as inputs. The artefact recommender 308 recommends the service per component that matches both resource and performance requirements of components. The infrastructure orchestrator 310 determines an IaC template from the repository and may customize infrastructure components and parameters. The service cloud Infrastructure may be provisioned in the cloud.

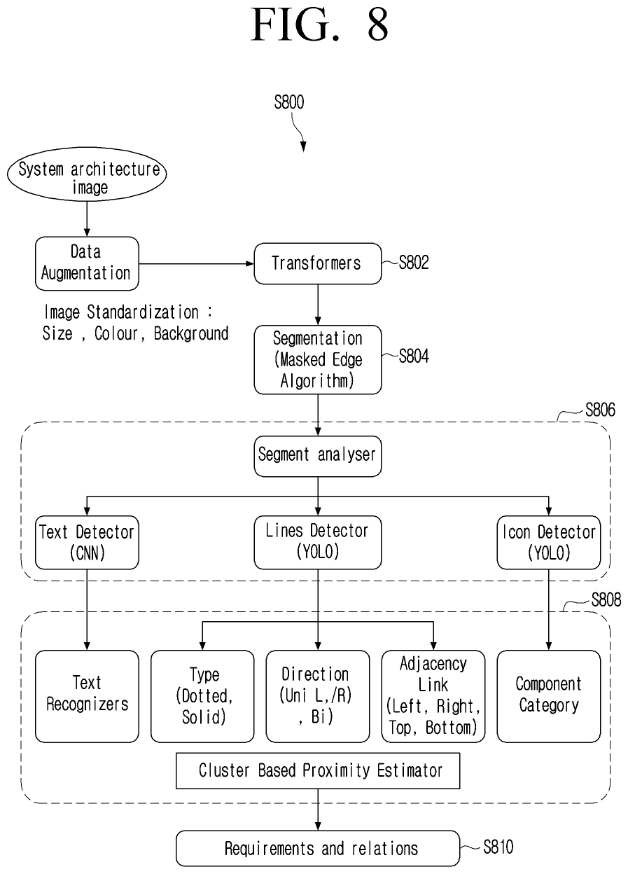

FIG. 8 illustrates various operations (S800) of the design decoder 306 included that forms part of the infrastructure provisioning system 300 explained in conjunction with the FIG. 4, according to one or more embodiments.

At operation S802, the system architecture images are input to a transformer engine. The transformer engine transforms, augments and standardize the images ready for segmentation. At operation S804, a masked edged segmentation technique segments the architecture images and detects the segments like texts, lines, icons from the architecture images. At operation S806 and operation S808, the segment analyzer includes a CNN based text detector, a text recognizer and a YOLO based custom line detector. The CNN based text detector detects the text in the detected segments. The text recognizer recognizes the given text and determines what text it is. The YOLO based custom line detector analyzes the line segments and determines the type of link it is. The segment analyzer can also detect the line types (Dotted or Solid Line), line direction (Uni-Directional Left/Right, Bi-Directional) and line adjacency (Line positioning: (left, right, top or bottom)). The YOLO based custom icons detector analyzes the icon objects and determines the type of icon. A cluster-based proximity estimator analyzes components recognized by the segment analyzers and associates them with defined component categories and relationships based on the proximity. At S810, all recognized and categorized components with their relationships are output in a final document JSON.

FIG. 9 illustrates operations (S900) of the artefact recommender 308 of the infrastructure provisioning system 300 explained in conjunction with the FIG. 5, according to one or more embodiments.

At operation S902, the requirements are input into a recommender technique. The system utilizes the component corpus 312 and the cloud component matrix to generate recommendations. At operation S904, the custom-designed cloud component feature matrix and its corresponding features are fed into a hybrid cascading recommender, resulting in a list of cloud-related components that meet requirements. At operation S906, a linear optimization technique is employed to identify the prioritized sequence of service components for each cloud from the list of identified resources. The cloud-related service components that offer the best price and performance may be created as a result.

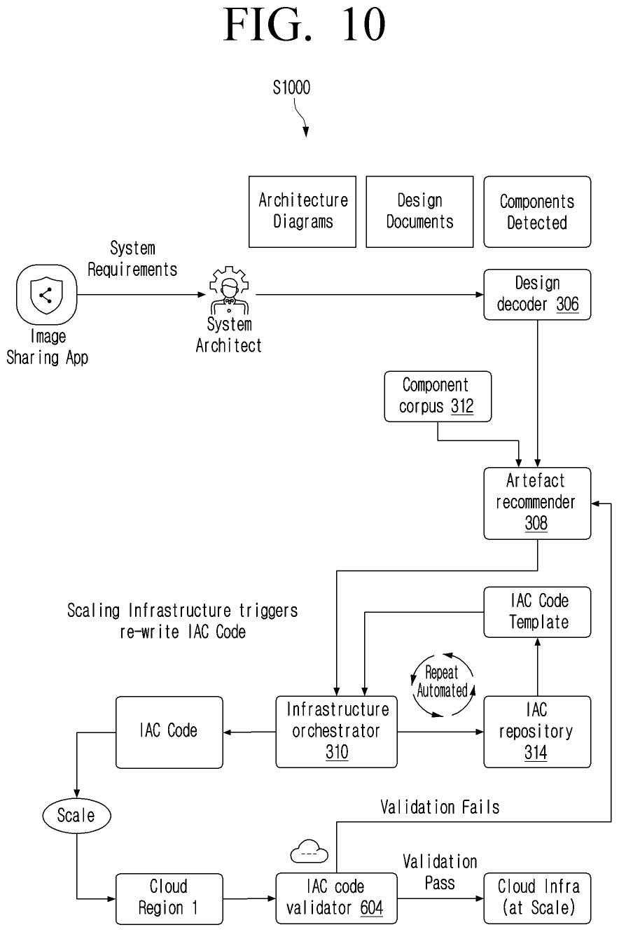

FIG. 10 illustrates an example scenario (S1000) of provisioning an image sharing application on an AWS platform®, according to one or more embodiments.

The design decoder 306 receives one or more system architecture designs for deployment of the image sharing application on the cloud platform. The design decoder 306 determines one or more design parameters by decoding the one or more system architecture designs. The one or more design parameters may include the system components, the interconnections between the system components, the performance requirements of the system components, and the resource requirements of the system components. The artefact recommender 308 determines service components for deployment of the image sharing application based on the one or more design parameters.

The infrastructure orchestrator 310 may be connected to the artefact recommender 308. The infrastructure orchestrator 310 determines an Infrastructure-as-Code (IaC) template for the service based on the interconnections between the system components and the service components, and deploys the application on the cloud platform based on the IaC template.

The IaC validator 604 validates the IaC template for errors and missing code components. The IaC validator 604 deploys the application on the cloud platform based on the validated IaC template. Further, the infrastructure orchestrator 310 determines the change in the system architecture design. Further, the infrastructure orchestrator 310 changes the IaC template based on the change in the system architecture design.

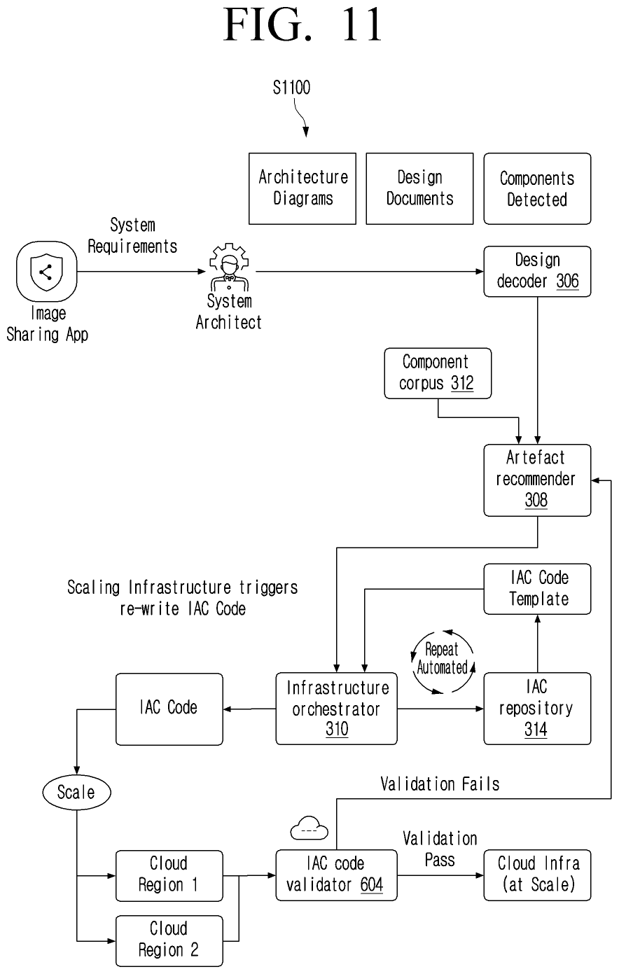

FIG. 11 illustrates an example scenario (S1100) of provisioning the image sharing application on the multi-cloud and multi-region deployment of services, according to one or more embodiments.

The design decoder 306 receives the one or more system architecture designs for deployment of the image sharing application on the cloud platform. Further, the design decoder 306 determines the one or more design parameters by decoding the one or more system architecture designs. The one or more design parameters may include the system components, the interconnections between the system components, the performance requirements of the system components, and the resource requirements of the system components. The artefact recommender 308 determines the service component for deployment of the image sharing application based on the one or more design parameters.

The infrastructure orchestrator 310 may be connected to the artefact recommender 308. The infrastructure orchestrator 310 determines the IaC template for the service based on the interconnections between the system components and the service components, and deploys the application on the cloud platform based on the IaC template.

The IaC validator 604 validates the IaC template for errors and missing code components. The IaC validator 604 deploys the application on the cloud platform based on the validated IaC template.

Further, the infrastructure orchestrator 310 determines the change in the system architecture design. The infrastructure orchestrator 310 changes the IaC template based on the change in the system architecture design.

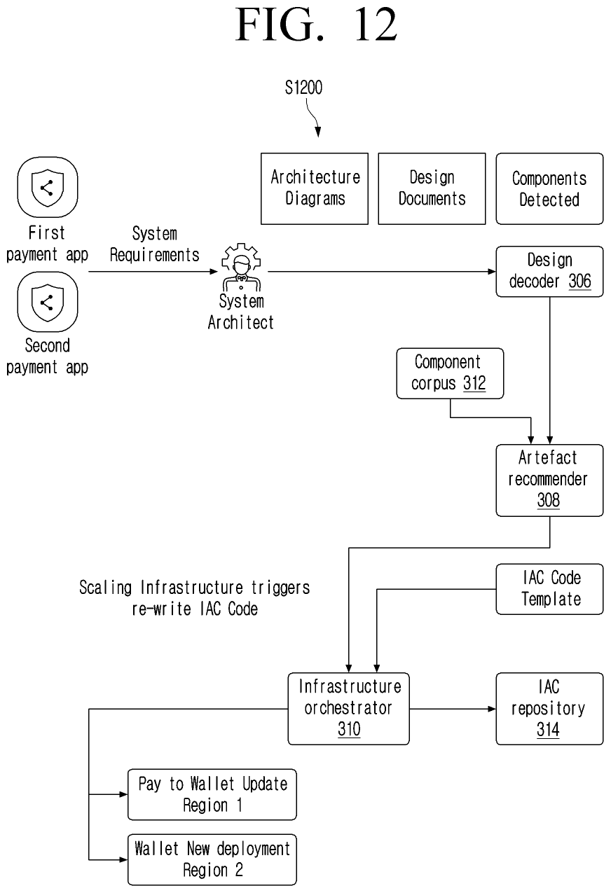

FIG. 12 illustrates an example scenario (S1200) of provisioning infrastructure for the revamped application (e.g., payment application or the like), according to one or more embodiments.

The design decoder 306 receives one or more system architecture designs for deployment of the payment application(s) on the cloud platform. Further, the design decoder 306 determines the one or more design parameters by decoding the one or more system architecture designs. The one or more design parameters may include the system components, the interconnections between the system components, the performance requirements of the system components, and the resource requirements of the system components. The artefact recommender 308 determines the service component for deployment of the payment application based on the one or more design parameters.

The infrastructure orchestrator 310 may be connected to the artefact recommender 308. The infrastructure orchestrator 310 determines the IaC template for the service based on the interconnections between the system components and the service components, and deploys the payment application on the cloud platforms based on the IaC template.

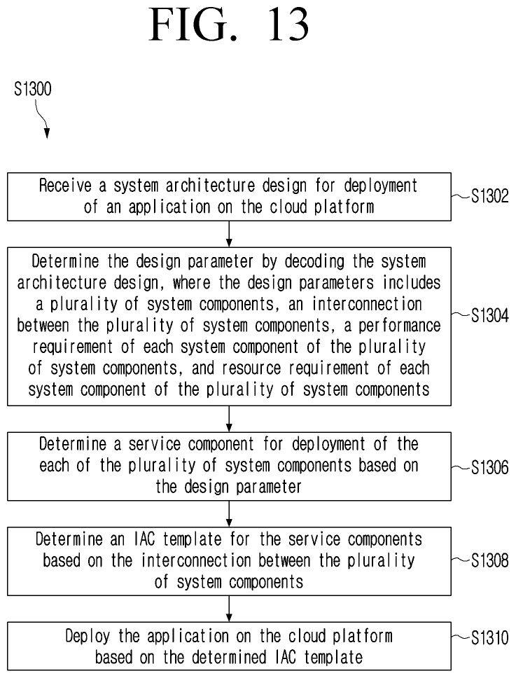

FIG. 13 illustrates a flow chart (S1300) of a method for automatic cloud agnostic infrastructure provisioning, according to one or more embodiments.

At S1302, the method may include receiving the system architecture design for deployment of an application on the cloud platform. At S1304, the method may include determining the design parameter by decoding the system architecture design. The design parameter may include the system components, interconnections between the system components, performance requirements of the system components, and resource requirements of the system components. At S1306, the method may include determining the service component for deployment of the system components based on the design parameter. At S1308, the method may include determining the IaC template for the service component based on the interconnections between the system components. At S1310, the method may include deploying the application on the cloud platform based on the determined IaC template.

According to one or more embodiments, the method may decode the architecture designs and documents. The method may identify components satisfying requirements across the cloud platforms. The method may provide the infrastructure orchestrator across the cloud platforms. The method may reduce time for getting industry standard IT Infrastructure that accelerates the time-to-market of a product and save significant cost.

The method may design and optimize the cloud infrastructure across the cloud platforms by identifying components and monitoring performance automatically based on the system requirements. The method may collect service reliability requirements of a service and may provision to the specifications, as well as iteratively orchestrate the service. The method according to one or more embodiments may reduce system deployment on-boarding time and costs.

The various actions, acts, blocks, operations, or the like in the flow charts (S800, S900, and S1300) may be performed in the order presented, in a different order or simultaneously. Further, in some embodiments, actions, acts, blocks, operations, or the like may be added or modified without departing from the scope of the disclosure.

Presented herein is the method and the infrastructure provisioning system 300 for establishing cloud independent infrastructure or transition from existing system diagrams. One or more embodiments may decode system diagrams and suggests cloud-related components and services for performing tasks across various cloud platforms. The suggested components and services may be transformed into infrastructure as code documentation, culminating in multi-cloud infrastructure provisioning with automation.

One or more embodiments may facilitate the development and deployment of cloud services across multiple platforms which may reduce on-boarding time for system deployment.

One or more embodiments may facilitate system component identification and decoding without manual intervention.

The foregoing descriptions of the embodiments may be modified or adapted for various applications without departing from the scope of the disclosure. It is also to be understood that the terms employed herein are for the purpose of description and are not limiting.

What is claimed is:

1. A method for automatic cloud agnostic infrastructure provisioning, comprising:
receiving at least one system architecture design for deployment of at least one application on a cloud platform;
determining:
one or more design parameters by decoding the at least one system architecture design, wherein the one or more design parameters comprise at least one of a plurality of system components,
one or more interconnections between the plurality of system components,
a plurality of performance requirements of the plurality of system components, and
a plurality of resource requirements of the plurality of system components;
determining, based on the one or more design parameters, at least one service component for deployment from among the plurality of system components;
determining at least one Infrastructure-as-Code (IaC) template for the at least one service component based on the one or more interconnections between the plurality of system components; and
deploying the at least one application on the cloud platform based on the at least one IaC template.

2. The method as claimed in claim 1, wherein the at least one service component meets the plurality of resource requirements and the plurality of performance requirements.

3. The method as claimed in claim 1, wherein the at least one system architecture design comprises a plurality of architecture design images of the at least one application and a plurality of design documents of the at least one application.

4. The method as claimed in claim 1, wherein the decoding the at least one system architecture design comprises:
segmenting the at least one system architecture design into a plurality of design segments;
detecting:
text associated with at least one system component of the plurality of system components in the plurality of design segments,
one or more links associated with the at least one system component in the plurality of design segments, and
one or more icons associated with the at least one system component in the plurality of design segments;
determining a plurality of types comprising one or more first types of the text, one or more second types of the one or more links, and one or more third types of the one or more icons; and
determining the one or more design parameters based on the plurality of types.

5. The method as claimed in claim 4, wherein the detecting the text comprises:
detecting at least one design segment from the plurality of design segments in which first text associated with the at least one system component is available;
removing a maximum level of background surrounding the first text;
segmenting the first text into a plurality of text segments; and
detecting the text by converting a plurality of single string characters from the plurality of text segments into words.

6. The method as claimed in claim 4, wherein the detecting the one or more links comprises:
detecting at least one design segment from the plurality of design segments in which at least one Region of Interest (ROI) is available;
determining a plurality of edges of the at least one ROI; and
detecting the one or more links based on the plurality of edges.

7. The method as claimed in claim 1, wherein the determining the at least one service component comprises:
receiving the one or more interconnections between the plurality of system components and metadata associated with the plurality of system components;
determining a plurality of recommended service components based on the one or more interconnections between the plurality of system components and the metadata; and
determining the at least one service component from the plurality of recommended service components based on at least one machine learning model and a plurality of characteristics of one or more cloud service providers.

8. The method as claimed in claim 7, wherein the determining the plurality of recommended service components comprises:
validating the plurality of system components to determine a validation result based on cloud component information retrieved from a component corpus database and a service component matrix, wherein the service component matrix comprises information about a plurality of requirements, with respect to a plurality of cloud services provided, of a plurality of service components;
determining a missing system component based on the validation result to obtain a set of system components; and
determining the plurality of recommended service components by mapping the set of system components to at least one first service component of the plurality of service components based on the one or more interconnections between the plurality of system components, and the metadata associated with the plurality of system components.

9. The method as claimed in claim 1, wherein the deploying the at least one application comprises:
obtaining at least one validated IaC template by validating the at least one IaC template for a plurality of errors and a plurality of missing code components; and
deploying the at least one application on the cloud platform based on the at least one validated IaC template.

10. The method as claimed in claim 1, further comprising:
determining a change in the system architecture design; and
automatically changing the IaC template based on the change in the system architecture design.

11. An infrastructure provisioning system for automatic cloud agnostic infrastructure provisioning, comprising:
one or more processors; and
memory storing instructions that, when executed by the one or more processors, cause the infrastructure provisioning system to:
receive at least one system architecture design for deployment of at least one application on a cloud platform;
determine:
one or more design parameters by decoding the at least one system architecture design, wherein the one or more design parameters comprise at least one of a plurality of system components,
one or more interconnections between the plurality of system components,
a plurality of performance requirements of the plurality of system components, and
a plurality of resource requirements of the plurality of system components;
determine, based on the one or more design parameters, at least one service component for deployment from among the plurality of system components;
determine at least one Infrastructure-as-Code (IaC) template for the at least one service component based on the one or more interconnections between the plurality of system components; and
deploy the at least one application on the cloud platform based on the at least one IaC template.

12. The infrastructure provisioning system as claimed in claim 11, wherein the at least one service component meets the plurality of resource requirements and the plurality of performance requirements.

13. The infrastructure provisioning system as claimed in claim 11, wherein the at least one system architecture design comprises a plurality of architecture design images of the at least one application and a plurality of design documents of the at least one application.

14. The infrastructure provisioning system as claimed in claim 11, wherein the one or more processors are configured to execute the instructions to cause the infrastructure provisioning system to:
segment the at least one system architecture design into a plurality of design segments;
detect:
text associated with at least one system component of the plurality of system components in the plurality of design segments,
one or more links associated with the at least one system component in the plurality of design segments, and
one or more icons associated with the at least one system component in the plurality of design segments;
determine a plurality of types comprising one or more first types of the text, one or more second types of the one or more links, and one or more third types of the one or more icons; and
determine the one or more design parameters based on the plurality of types.

15. The infrastructure provisioning system as claimed in claim 14, wherein the one or more processors are configured to execute the instructions to cause the infrastructure provisioning system to:
detect at least one design segment from the plurality of design segments in which first text associated with the at least one system component is available;
remove a maximum level of background surrounding the first text;
segment the first text into a plurality of text segments; and
detect the text by converting a plurality of single string characters from the plurality of text segments into words.

16. The infrastructure provisioning system as claimed in claim 14, wherein the one or more processors are configured to execute the instructions to cause the infrastructure provisioning system to:
detect at least one design segment from the plurality of design segments in which at least one Region of Interest (ROI) is available;
determine a plurality of edges of the at least one ROI; and
detect the one or more links based on the plurality of edges.

17. The infrastructure provisioning system as claimed in claim 11, wherein the one or more processors are configured to execute the instructions to cause the infrastructure provisioning system to:
receive the one or more interconnections between the plurality of system components and metadata associated with the plurality of system components;
determine a plurality of recommended service components based on the one or more interconnections between the plurality of system components and the metadata; and
determine the at least one service component from the plurality of recommended service components based on at least one machine learning model and a plurality of characteristics of one or more cloud service providers.

18. The infrastructure provisioning system as claimed in claim 17, wherein the one or more processors are configured to execute the instructions to cause the infrastructure provisioning system to:
validate the plurality of system components to determine a validation result based on cloud component information retrieved from a component corpus database and a service component matrix, wherein the service component matrix comprises information about a plurality of requirements, with respect to a plurality of cloud services provided, of a plurality of service components;
determine a missing system component based on the validation result to obtain a set of system components; and
determine the plurality of recommended service components by mapping the set of system components to at least one first service component of the plurality of service components based on the one or more interconnections between the plurality of system components, and the metadata associated with the plurality of system components.

19. The infrastructure provisioning system as claimed in claim 11, wherein the one or more processors are configured to execute the instructions to cause the infrastructure provisioning system to:
obtain at least one validated IaC template by validating the at least one IaC template for a plurality of errors and a plurality of missing code components; and
deploy the at least one application on the cloud platform based on the at least one validated IaC template.

20. A non-transitory computer-readable recording medium having instructions recorded thereon, that, when executed by one or more processors, cause the one or more processors to:
receive at least one system architecture design for deployment of at least one application on a cloud platform;
determine:
one or more design parameters by decoding the at least one system architecture design, wherein the one or more design parameters comprise at least one of a plurality of system components,
one or more interconnections between the plurality of system components,
a plurality of performance requirements of the plurality of system components, and
a plurality of resource requirements of the plurality of system components;
determine, based on the one or more design parameters, at least one service component for deployment from among the plurality of system components;
determine at least one Infrastructure-as-Code (IaC) template for the at least one service component based on the one or more interconnections between the plurality of system components; and
deploy the at least one application on the cloud platform based on the at least one IaC template.
